(19) United States
(12) Patent Application Publication
(10) Pub. No.: US 2020/0217743 A1
(43) Pub. Date: Jul. 9, 2020

(54) METHOD OF TESTING THE SEAL OF TRANSPORTABLE CONTAINERS, SUCH AS SUITCASES, TRUNKS, CASES AND THE LIKE

(71) Applicant: G.T. LINE S.R.L., Valsamoggia, Frazione Crespellano (IT)

(72) Inventors: Massimo TONELLI, Bologna (IT); Giovanni AUSENDA, Casorate Primo (IT)

(21) Appl. No.: 16/632,108

(22) PCT Filed: Jul. 19, 2017
(86) PCT No.: PCT/IT2017/000147

§ 371 Date: Jan. 17, 2020

(51) Int. Cl. G01M 3/22; G01M 3/20

(52) U.S. Cl. CPC G01M 3/229; G01M 3/3281; G01M 3/202

(57) ABSTRACT

A method of testing the seal of transportable containers, such as suitcases, trunks, and cases, which form inside them, in at least one closed configuration, at least one compartment to be seal tested, the method includes the following steps: accommodating a container to be tested, in the closed configuration, in a saturation chamber; dispensing a tracer gas in the saturation chamber; and lowering the pressure value inside the compartment. The method further includes waiting for a preset time, keeping the saturation chamber closed; drawing an air sample from the compartment; and measuring the actual concentration of tracer gas in the air sample drawn from the compartment. Thus, an actual concentration higher than a reference value, correlated to the normal concentration of tracer gas in the atmosphere, can indicate the entry of the tracer gas in the compartment and a condition of at least potential defectiveness of the seal of the compartment of the container.

### TECHNICAL FIELD

The present disclosure relates to a method of testing the seal of transportable containers, such as suitcases, trunks, cases and the like. The present disclosure also relates to an apparatus for testing the seal of said transportable containers.

### BACKGROUND

Among the various types of transportable containers that are commercially available, it is possible to identify a product type composed of cases, trunks or suitcases, which are capable of ensuring the integrity of their contents by virtue of suitable technical solutions and an appropriate choice of materials.

In greater detail, these containers usually have a high impact resistance and, when arranged in the closed configuration, isolate the compartment formed inside them from the surrounding environment, effectively preventing the entry of water, dust and contaminants in general.

Due to these particularities, products of this type are particularly appreciated by various types of professional customers, who need to transport even over long distances equipment and tools that are highly sensitive to impacts or contaminations.

Indeed the need to protect effectively objects which are so delicate and at the same time often also expensive evidently makes it crucial to comply with the requirements of strength and seal indicated above, on penalty of client dissatisfaction and failure on the market.

As regards in particular the seal, it should be noted that it is usually ensured by a gasket that is arranged between the edges that are adjacent (in the closed configuration) of the half-shells that form the container. Sometimes, however, during the production process, problems of various kinds occur which cause an irregular mating between the half-shells or damage (and/or loss of integrity) to said gasket. Obviously, in all these cases the seal is irreparably compromised.

Therefore, manufacturers must provide for spot checks in order to ascertain the actual seal and therefore the ability to prevent entry of water or other impurities into the compartment, at least within certain preset conditions.

The particular characteristics of these containers and in general the requirements of the reference sector and of the manufacturers themselves, however, make it very complicated to define valid tests, most of all because it is essentially impossible to resort to the seal testing procedures that are typically used in other sectors.

It should in fact be noted first of all that despite being tough, the containers are usually made of nonferrous material which is in any case at least partially deformable. Therefore, resorting to measurements of deformation or of any mechanical kind, which are indeed adopted in other sectors, is essentially impossible, since the structure of the container changes as the internal and external pressure conditions vary.

At the same time, it should also be noted that measurements of any pressure variations caused by the leaks that one wishes to detect (even if performed with precision electronic sensors) require very long times and therefore are not suitable in the reference production context, which requires quick and prompt responses.

Known testing methods, such as the ones that resort to pressure drop technology (also known as “drop test”) or vacuum rise technology, therefore are not decisive and/or are unreliable and therefore cannot be applied in production.

More generally, each company is forced to devise extemporaneous and nonrepeatable tests, finding difficulty in defining testing methods that are objective and reliable and can be performed in short times on containers having dimensions and shapes that can be even very different.

### SUMMARY

The aim of the present disclosure is to solve the problems described above, providing a method that allows to check objectively and effectively the seal of transportable containers such as suitcases, trunks, cases and the like.

Within this aim, the disclosure provides an apparatus that allows to perform objectively and effectively the testing of the seal of transportable containers such as suitcases, trunks, cases and the like.

The disclosure also proposes a method that can be performed in short times.

The disclosure further proposes a method and an apparatus that ensure high reliability in operation and are versatile, the same method and/or apparatus being usable to test containers of various shapes and dimensions.

The disclosure also proposes an apparatus that adopts a technical and structural architecture that is alternative to those of apparatuses of the known type.

The disclosure proposes a method that can be performed easily starting from commonly commercially available elements and materials.

The disclosure also proposes a method that can be performed in a simple manner.

This aim and these and other advantages which will become better apparently hereinafter are achieved by providing a method according to claim 1 and by an apparatus according to claim 10.

### BRIEF DESCRIPTION OF THE DRAWINGS

Further characteristics and advantages of the disclosure will become better apparent from the description of a preferred but not exclusive embodiment of the method and of the apparatus according to the disclosure, with the apparatus shown by way of nonlimiting example in the accompanying drawings, wherein:

FIG. 1 is a perspective view of the apparatus according to the disclosure; and

FIG. 2 is a circuit diagram of the apparatus of FIG. 1.

### DETAILED DESCRIPTION OF THE DRAWINGS

The disclosure relates to a method for testing the seal of transportable containers A, such as suitcases, trunks, cases and the like. Further, and with particular reference to the figures, it is specified right now that the present description also relates to an apparatus which, as will become better apparent hereinafter, allows to perform said method, and is generally designated by the reference numeral 1.

The containers A cited above form inside them, in at least one closed configuration, at least one compartment B to be seal tested.

It is therefore appropriate to specify that the protective scope claimed herein is to be understood as extending to the testing of the seal of transportable containers A of any type and for any customer, be they intended for professional use or simply used for leisure trips or journeys.

Nevertheless, in the preferred application the container A (be it a suitcase, a case, a trunk, a trolley, or others) is used for activities of the professional type (installations, assemblies, maintenance, periodic checks, etc.) for which it is necessary to have specific tools or equipment, which can therefore be accommodated in the compartment B.

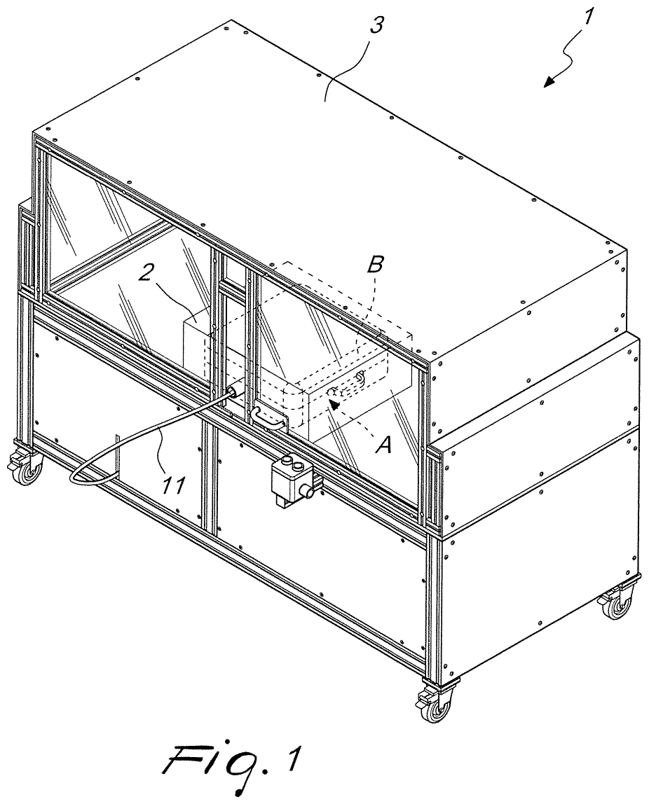

Indeed in this context, due to the sensitivity of the equipment and their far from negligible cost, the containers A must ensure high impact resistance and, when arranged in the closed configuration (as in FIG. 1), must ensure the seal of the compartment B, effectively preventing the entry of water, dust and contaminants in general.

This seal, which is the subject matter of the test performed by the method and/or by the apparatus 1 according to the disclosure, is usually ensured (as well as by other solutions, if any) by a gasket made of polymeric material, which, when the container A is in the closed configuration, is interposed between the adjacent and mutually mated edges of the half-shells that normally constitute the container A and delimit the compartment B.

According to the disclosure, the method includes in a step a., in accommodating in a saturation chamber 2 a container A to be (seal) tested, arranged in the closed configuration, indeed the one in which the seal of the internal compartment B must be ensured.

Subsequently, in a step b., the method provides for dispensing a tracer gas inside the saturation chamber 2.

In greater detail, in the preferred application, mentioned by way of nonlimiting example of the application, said tracer gas is helium, since as will become better apparent hereinafter its properties are particularly indicated for the purposes defined herein.

In the continuation, therefore, reference shall be made to this preferred application, but it is appropriate to stress that any indication regarding the use of helium must be understood as being extended to any other gaseous substance that can in any way be used as a tracer gas.

As is evident also from the accompanying figures, preferably the saturation chamber 2 is chosen with dimensions that are as close as possible to those of the container A to be tested (or of the largest container A within the range that one wishes to test), so that the free volume to be saturated with the tracer gas is as small as possible. In this manner it is in fact possible to avoid large consumptions of tracer gas and at the same time ensure that the concentration of helium outside the container A is in the highest possible percentage (equal to, or even greater than, 50%).

It is specified that the saturation chamber 2 obviously will be kept closed during the execution of step b.

After filling the saturation chamber 2 (outside the container A) with the tracer gas, the method provides, in a step c., for lowering the value of the pressure inside the compartment B. This determines a condition of difference in pressure inside the saturation chamber 2 (which of course in the meantime must be kept closed), since a pressure that is lower than the one measurable outside it occurs inside the compartment B.

It is specified further that the method according to the disclosure can be performed by reversing the chronological order of execution of steps b. and c. and therefore by first of all lowering the pressure value inside the compartment B and then dispensing helium into the saturation chamber 2.

In any case, in this manner it is possible to check the effectiveness of the sealing system of the compartment B: in the presence of defects of the system, part of the tracer gas in fact penetrates the transportable container A.

In order to allow indeed any entry of tracer gas into the compartment B, the method provides, in a step d. which follows steps b. and c., for waiting for a preset time while keeping the saturation chamber 2 closed.

At the end of step d., the method provides, in a step e., for drawing a sample of air from the compartment B to then measure, in a step f, the actual concentration of tracer gas therein.

An actual concentration that exceeds a reference value, correlated to the normal concentration of tracer gas in the atmosphere (in the case of helium, variable on average between 2 and 5 ppm), can thus be an indication of the entry of the tracer gas into the compartment B and therefore indicates a condition of at least potential defectiveness of the seal of the compartment B of the container A, thus achieving the intended aim.

Evidently, taking into account a possibly accepted minimum leak, measurement errors (which in turn depend also on the method chosen for measurement) and any tolerances linked to the variability of the parameters involved, the seal of the container A is preferably considered defective only when the actual concentration exceeds a reference value that is obtained as a function of the normal concentration and of a safety parameter that is chosen appropriately.

In this context, resorting to helium as a tracer gas is of particular practical interest: helium is in fact a gas which does not combine with other molecules of air and therefore its diffusion and concentration in a given volume can be considered uniform in the short term. Therefore, the sample drawn will have an actual concentration that derives indeed from the quantity of helium absorbed and diluted in the internal volume of the container A.

In particular, and although different practical choices are not excluded, in step c. the pressure value inside the compartment B is lowered until it equals a predefined value chosen in a range between −70 relative millibar and −130 relative millibar and preferably equal to −100 relative millibar.

As is known, in the background art and in the present description, the relative bar (and therefore the relative millibar, which is a submultiple thereof) is a unit of measurement of the relative pressure in bars (where a bar corresponds to 10⁵ Pa) with respect to atmospheric pressure.

The choice to lower the pressure inside the compartment B to the value of −100 relative millibar is of particular practical interest.

It should in fact be noted that in the field some specifications provide that a transportable container A is declared noncompliant with seal requirements if, after keeping it for thirty minutes in a tank full of water at a depth of 1 meter, the presence of even just one drop of water (0.04 cc of water, equal to an instantaneous loss of approximately 1.3×10⁻³ cc/min of water) is observed inside the compartment B.

The preferred pressure value for the execution of step c. (−100 relative millibar, indeed) indeed corresponds to the pressure applied by a column of water at a depth of 1 meter and, in manners which are known and fully evident for the person skilled in the art, it is easy to calculate the concentration (acceptable limit) of tracer gas that corresponds to the entry of a drop of water. By way of example, it is noted that in the case of helium and assuming that a saturation thereof in the air equal to 50% has been obtained in step b., the limit value of instantaneous leakage is equal to 0.585 cc/min of helium.

The goal of step f is therefore to check whether the actual concentration is equal to or greater than the normal concentration of tracer gas in the atmosphere, added to the one that corresponds to the entry of a drop of water. If the actual concentration is lower than the sum of the two cited concentrations, the container A passes the seal test also according to the known specifications mentioned earlier.

Usefully, the method according to the disclosure provides, at least during step b., for enclosing the saturation chamber 2 in an auxiliary chamber 3. The latter thus performs the function of protecting the saturation chamber 2 (isolating it) against any currents and/or flows of air that may be present in the surrounding environment. Otherwise, these might remove or change the concentration of the tracer gas outside the container A.

Advantageously, and with further reference to the parameters of the method according to the disclosure, it is stressed that the preset wait time (step d.) is chosen as a function of the volume of the compartment B, since the variation and the quantity of the concentration of tracer gas depends on it and therefore this allows the entry of an appreciable quantity of tracer gas.

Assuming (merely as a nonlimiting example) that containers A with a compartment B having a volume comprised between five normal liters and 100 normal liters are tested, this preset time can consequently vary between 1 minute and 4 minutes. This is in any case a very short time (far shorter than the 30 minutes provided by standards for testing in water) and is in any case compatible (comparable) with normal cycle times provided for the production and assembly of the containers A.

Favorably, the method according to the disclosure provides, in a step g. which follows step d. and precedes step e. (therefore before drawing the air sample), for raising the pressure value inside the compartment B until the value of the atmospheric pressure is equaled (or in any case returning it as close as possible to the latter).

Without this last refinement, one might run the risk that drawing the sample from the compartment B, which is already under partial vacuum, might cause the collapse of the walls of the container A.

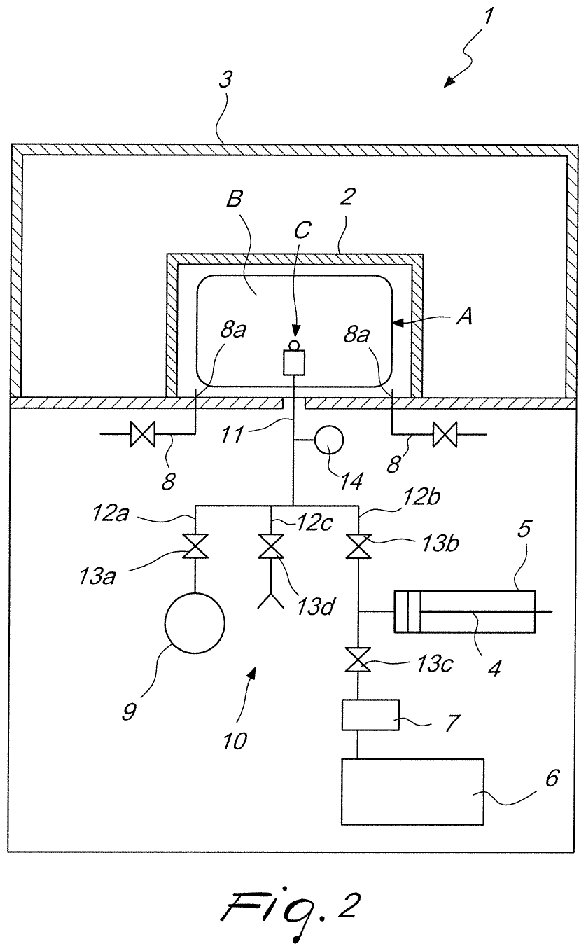

In one embodiment that is of considerable practical interest (which corresponds to the embodiment shown schematically in the accompanying figures, in particular FIG. 2), mentioned by way of nonlimiting example of the application of the disclosure, the withdrawal step e. is performed by suction. Suction is performed by a piston 4, which can slide hermetically within a cylinder 5, during its forward stroke (intake stroke), which is performed in a first sliding direction.

Moreover, this embodiment allows to draw, at each test, a constant volume of air (contributing to the objectivity and repeatability of the test), wherein said volume is equal to the useful portion of the internal space of the cylinder 5, delimited by the piston 4 at the end of its forward stroke.

According to some embodiments of particular practical interest, step f is performed by a verification device 6 that is chosen from a mass spectrometer, an infrared concentration measurement instrument, and a heat conductivity concentration measurement instrument; in greater detail, preferably the verification device 6 is indeed a mass spectrometer.

This last choice in fact allows to obtain a precise and reliable answer, with high sensitivity, in particularly short times; in fact, by resorting to this spectrometer one should note that a variation of 10 ppm already can be identified easily.

With further reference to the method that can be performed with the apparatus 1 of the accompanying figures, the air sample is propelled towards the verification device 6 by the piston 4 during its return stroke (delivery stroke) inside the cylinder 5, which is performed in a second sliding direction that is opposite to the first one.

More precisely, the verification device 6 can be associated with an analysis chamber 7, which is connected to the cylinder 5 in order to accommodate the air sample to be analyzed by means of the device 6.

As already anticipated, therefore, like the method, the present description relates to an apparatus 1 for testing the seal of transportable containers A, such as suitcases, trunks, cases and the like. The apparatus 1 can be used to perform a method according to one or more of the preceding claims, and all the specifications and indications given above, in relation indeed to the method, can be extended to it.

Among them, therefore, according to the disclosure, the apparatus 1 comprises first of all at least one saturation chamber 2 in order to accommodate a container A which forms inside it, in at least one closed configuration, at least one compartment B to be seal tested. The saturation chamber 2 therefore allows to perform step a. of the method according to the disclosure. Further, the apparatus 1 comprises means for dispensing a tracer gas (constituted preferably but not exclusively by helium) inside the saturation chamber 2. These dispensing means therefore allow to perform step b. of the method according to the disclosure. They can provide for one or more tubes 8 fed by one or more helium tanks and facing from opposite sides, at respective nozzles 8a, the saturation chamber 2. These nozzles 8a can be distributed appropriately along the floor and/or side walls and/or ceiling of the saturation chamber 2, in order to ensure optimum conditions of (uniform) diffusion of the tracer gas.

The apparatus 1 further comprises a vacuum pump 9, which can be connected temporarily to the compartment B, in order to lower the pressure value inside it (and therefore perform step c. of the method according to the disclosure).

The apparatus 1 further comprises means for drawing a sample of air of the compartment B (to perform step e. of the method according to the disclosure) and a verification device 6, associated with the cited withdrawal means, to measure the actual concentration of tracer gas in the air sample drawn from the compartment B (and therefore perform step f of the method according to the disclosure).

As already pointed out in the preceding pages, if the device 6 detects an actual concentration that exceeds a reference value, which is correlated to the normal concentration of tracer gas in the atmosphere, this may indicate the entry of the tracer gas into the compartment B and a condition of at least potential defectiveness of the seal of the compartment B of the container A.

In particular, the apparatus 1 also comprises an auxiliary chamber 3, which accommodates at least temporarily the saturation chamber 2 (at least during the execution of step b.), in order to protect the saturation chamber 2 against currents and/or flows of air that may be present in the surrounding environment.

Even more particularly, the withdrawal means comprise a cylinder 5, which can be connected to the compartment B and to the verification device 6, and a piston 4, which can slide hermetically within the cylinder 5. As already shown, this allows to extract the air sample (step e.) during the forward stroke of the piston 4, performed in a first sliding direction, and the conveyance of the air sample toward the verification device 6 (and toward the analysis chamber 7) during its return stroke, which is performed in a second sliding direction which is the opposite with respect to the first one.

Usefully, the verification device 6 that is part of the apparatus 1 is chosen from a mass spectrometer, an infrared concentration measurement instrument, and a heat conductivity concentration measurement instrument, and preferably the verification device 6 is a mass spectrometer.

In the embodiment proposed in the accompanying figures by way of nonlimiting example of the application of the disclosure, the apparatus 1 comprises a pneumatic circuit 10 provided with a main duct 11 which can be connected at one end to the compartment B.

As regards the connection, it should be noted that different types of transportable container A that require seal testing have a valve for compensation of the internal pressure in case of transport by air, which equalizes the pressure variations and is provided with a specific membrane that allows the permeation of air but not of liquids.

The connection of the duct 11 to the compartment B (which is required to perform step c. and steps d., e. and f that follow) can be performed preferably indeed at the hole C that is normally provided on one of the half-shells of the container A and is designed for the subsequent insertion coupling of the compensation valve (which is not the subject of testing and will be fitted after said testing).

Obviously, if the container A to be tested is not provided with insertion coupling holes C for compensation valves, it is possible is to study different solutions for the connection of the duct 11 to the compartment B.

The connection (at the compensation valve or not) can be provided partially or completely already prior to the execution of step a. or after it, on condition of completing it before step c. (since, as will become apparent hereinafter, this step is performed indeed by virtue of the pneumatic circuit 10).

On the opposite side with respect to the end of the duct 11 that can be connected to the compartment B, the main duct 11 branches into at least three channels 12a, 12b, 12c, which are affected by a plurality of adjustment valves 13a, 13b, 13c, 13d.

A first channel 12a leads to the vacuum pump 9: by moving a first adjustment valve 13a to a free transit arrangement, it is therefore possible to connect the vacuum pump 9 to the compartment B in order to perform step c., while in the remaining steps of the method the first valve 13a can close the first channel 12a.

A second channel 12b leads to the withdrawal means and to the verification device 6, which can be connected to the compartment B in order to perform steps e. and E. In greater detail, by arranging in the free transit configuration a second adjustment valve 13b (and keeping closed a third adjustment valve 13c, which is proximate to the verification device 6), it is possible to perform the step e. by suction, by virtue of the forward stroke of the piston 4. By reversing the arrangement of the second valve 13b and of the third valve 13c, the piston 4 can instead push the air sample toward the verification device 6 and the analysis chamber 7 in order to perform step E.

The circuit 10 also comprises a third channel 12c, which is connected to the outside environment. When a fourth adjustment valve 13d, indeed arranged along the third channel 12c, is moved into the free transit arrangement, it is possible to perform step g, making air at atmospheric pressure enter the compartment B.

It should be noted that a pressure gauge 14, or other pressure measurement element, is also arranged along the duct 11, so that it is possible to monitor the pressure value in the compartment B during step c. (and to promptly interrupt the action of the vacuum pump 9 when the desired conditions are reached).

The execution of the method and the operation of the apparatus 1 according to the disclosure are therefore evident from what has been described so far: by generating a pressure difference between the compartment B and the remaining portion of the saturation chamber 2 it is possible to induce the entry of tracer gas into the compartment B in case of a defective seal. By measuring therefore the concentration of tracer gas in a sample of air drawn subsequently, and being of course able to know the normal concentration of the tracer gas in atmospheric air, it is thus possible to identify the defective containers A, for which it will be possible to observe in the sample an actual concentration of helium that is higher than that of atmospheric air.

In the presence of defects of the sealing system of the container A, the external positive pressure of the helium-saturated air and the partial vacuum inside the compartment B cause the absorption of a quantity of helium that is proportional to the value of the leak that is present.

It is further possible to associate with the verification device 6 electronic units capable of generating automatically a signal (of the PASS/FAIL type, for example) intended to report the outcome in a rapid and easily identifiable manner (also to activate promptly adequate countermeasures in case of a negative outcome).

In practice, therefore, with respect to known tests that follow the specifications imposed by some standards in the field, which provide for the immersion of the containers A in water to then check for the presence/absence of drops after a preset time, the disclosure provides for replacing the water with a tracer gas (preferably helium).

The use of gas has several benefits.

First of all, differently from a liquid, the gas can easily penetrate the compartment B even through micro-defects or porosities and therefore ensures a seal check that is absolutely reliable and dependable. It should in fact be noted that known methods do not allow to check and identify micro-imperfections, which are in any case capable of compromising the effectiveness of the sealing system.

Furthermore, the transit time in case of leaks is significantly shorter than that of water or other liquids: this allows to keep the overall testing time extremely short, making it compatible with production times and, even more importantly, allowing 100% testing of the manufactured containers A, without having to be limited to a spot check.

Moreover, the method and the apparatus 1 according to the disclosure allow testing in compliance with the specifications mentioned several times, obtaining however the desired outcome without having to resort to water and therefore without wetting or handling the product to check for the presence of leaks.

However, while checking for the presence or absence of a drop is performed visually (and is therefore subject to errors and inaccuracies), testing of the air sample is performed electronically, therefore in a manner that is certainly more reliable and objective.

More generally, by virtue of the method and the apparatus 1 according to the disclosure it is possible to perform objective, effective and global testing, in which the measurement of any leak that is obtained is the sum of all the micro-defects, if any, and is not necessarily of a single point and/or for example of the gasket alone.

By resorting to the cited electronic unit (and/or to adequate control software) it is further possible to automate testing, recording over time the values obtained and with maximum repeatability of the test.

It should be noted further that it is possible to resort to the same apparatus 1 according to the disclosure (and obviously to the same steps of the method according to the disclosure) in order to test containers A of different shapes and dimensions (of course smaller than those of the saturation chamber 2), ensuring maximum versatility and practicality.

In practice it has been found that the method and the apparatus according to the disclosure fully achieve the intended aim, since the use of a tracer gas capable of penetrating the internal compartment of the container to be tested, placed in partial vacuum beforehand, allows to check objectively and effectively the seal of transportable containers such as suitcases, trunks, cases and the like.

The disclosure thus conceived is susceptible of numerous modifications and variations, all of which are within the scope of the appended claims; all the details may further be replaced with other technically equivalent elements.

In the exemplary embodiments, individual characteristics, given in relation to specific examples, may actually be interchanged with other different characteristics that exist in other exemplary embodiments.

In practice, the materials used, as well as the dimensions, may be any according to the requirements and the state of the art.

1-14. (canceled)

15. A method of testing the seal of transportable containers, said containers forming inside them, in at least one closed configuration, at least one compartment to be seal tested, comprising the following steps:
a. accommodating a container to be tested, in a closed configuration, in a saturation chamber,
b. dispensing a tracer gas in said saturation chamber,
c. lowering the pressure value inside the compartment,
d. waiting for a preset time, keeping said saturation chamber closed,
e. drawing an air sample from the compartment, and
f. measuring an actual concentration of tracer gas in the air sample drawn from the compartment, an actual concentration higher than a reference value, correlated to the normal concentration of tracer gas in the atmosphere, indicating an entry of the tracer gas in the compartment and a condition of at least potential defectiveness of a seal of the compartment of the container.

16. The method according to claim 15, wherein said tracer gas is helium.

17. The method according to claim 15, wherein said step c. includes lowering the value of the pressure inside the compartment until it equals a predefined value chosen in a range between −70 relative millibar and −130 relative millibar.

18. The method according to claim 15, providing, at least during said step b., for enclosing said saturation chamber in an auxiliary chamber, for the protection of said saturation chamber against currents and/or flows of air that may be present in the surrounding environment.

19. The method according to claim 15, wherein said preset time is chosen as a function of a volume of the compartment in order to allow the entry of an appreciable quantity of tracer gas into the compartment.

20. The method according to claim 15, providing, in a step g. following said step d. and preceding said step e., for raising a value of the pressure inside the compartment until a value of the atmospheric pressure is equaled.

21. The method according to claim 15, wherein said step e. of drawing an air sample is performed by suction, on the part of a piston configured to slide hermetically within a container, during a forward stroke of the piston performed in a first sliding direction.

22. The method according to claim 15, wherein said step f is performed by a verification device chosen from a mass spectrometer, an infrared concentration measurement instrument, and a heat conductivity concentration measurement instrument.

23. The method according to claim 22, wherein said air sample is pushed toward said verification device by said piston, during a return stroke of the piston inside said cylinder, performed in a second sliding direction which is opposite to the first direction.

24. An apparatus for testing the seal of transportable containers for performing a method according to claim 15, said apparatus comprising:
a saturation chamber for accommodating a container that forms inside it, in at least one closed configuration, at least one compartment to be seal tested,
means for dispensing a tracer gas inside said saturation chamber,
a vacuum pump configured to be connected temporarily to the compartment, in order to lower the pressure value inside the compartment,
means for drawing an air sample from the compartment,
a verification device, associated with said withdrawal means, configured for measuring the actual concentration of tracer gas in the air sample drawn from the compartment, an actual concentration higher than a reference value, correlated to the normal concentration of tracer gas in the atmosphere, indicating the entry of the tracer gas in the compartment and a condition of at least potential defectiveness of the seal of the compartment of the container.

25. The apparatus according to claim 24, further comprising an auxiliary chamber, which accommodates at least temporarily said saturation chamber, for the protection of said saturation chamber against any currents and/or streams of air that are present in the surrounding environment.

26. The apparatus according to claim 24, wherein said means for drawing comprise a cylinder, which can be connected to the compartment and to said verification device, and a piston, which can slide hermetically inside said cylinder, for the withdrawal of the air sample during the forward stroke performed in a first sliding direction, and the conveyance of the air sample toward said verification device during the return stroke performed in a second sliding direction that is opposite to the first direction.

27. The apparatus according to claim 24, wherein said verification device is chosen from a mass spectrometer, an infrared concentration measurement instrument and a heat conductivity concentration measurement instrument.

28. The apparatus according to claim 24, further comprising a pneumatic circuit provided with a main duct configured to be connected, at one end, to the compartment, on the opposite side with respect to said end said main duct branching into at least three channels, controlled by a plurality of adjustment valves, a first said channel leading to said vacuum pump, a second said channel leading to said withdrawal means and to said verification device, and a third said channel being connected to the outside environment.
